(19) United States
(12) Patent Application Publication
(10) Pub. No.: US 2015/0055063 A1
(43) Pub. Date: Feb. 26, 2015

(54) DISPLAY APPARATUS

(71) Applicant: InnoLux Corporation, Jhu-Nan (TW)

(72) Inventor: Chih-Yung HSIEH, Jhu-Nan (TW)

(21) Appl. No.: 14/464,124

(22) Filed: Aug. 20, 2014

Related U.S. Application Data
(60) Provisional application No. 61/869,304, filed on Aug. 23, 2013.

(30) Foreign Application Priority Data
Nov. 26, 2013 (TW) 102143022

(51) Int. Cl. G02F 1/00; G02F 1/1335; G02F 1/1343

(52) U.S. Cl. CPC G02F 1/0045; G02F 1/134309; G02F 1/133528; G02F 1/133512
USPC 349/99; 349/139; 349/110

(57) ABSTRACT

A display apparatus includes a first substrate, a second substrate and a liquid crystal layer. The first substrate has a curved first side. The Range of curvature radius of the first side is between 500 mm and 10000 mm. On the first substrate is defined at least a datum line. The included angle of the datum line and the first side is between 80 degrees and 100 degrees. The second substrate is disposed opposite to the first substrate. The liquid crystal layer has a plurality of liquid crystal molecules. Wherein, the liquid crystal molecules at the datum line corresponding in a pixel area have a first tilt direction and a second tilt direction respectively, and the first tilt direction and the second tilt direction are different.

### CROSS REFERENCE TO RELATED APPLICATIONS

The non-provisional patent application claims priority to U.S. provisional patent application with Ser. No. 61/869,304 filed on Aug. 23, 2013 and under 35 U.S.C. §119(a) on Patent Application No(s). 102143022 filed in Taiwan, Republic of China on Nov. 26, 2013. This and all other extrinsic materials discussed herein are incorporated by reference in their entirety.

### BACKGROUND OF THE INVENTION

1. Field of Invention

The present invention relates to a display apparatus, and more particularly, to a display device comprising a curved panel.

2. Related Art

Flat display apparatus, such as liquid crystal display apparatus, is advantageous for its low power consumption, low heating value, light weight, and non-radiative property. Thus, flat display apparatus is now applied in several kinds of electronic products, gradually replacing the traditional cathode ray tube (CRT) display apparatus.

Take liquid crystal display apparatus for example, conventional liquid crystal display device includes a liquid crystal display (LCD) panel and a backlight module disposed opposite to the liquid crystal display panel. The liquid crystal display panel includes a plurality of pixels aligned as arrays. The light from the backlight module is illuminated through the liquid crystal display panel, such that an image is generated by the pixels on the liquid crystal display panel showing color.

In order to meet the various needs, the novel display devices are developed constantly for providing better display quality to users. Therefore, the present invention provides a new curved display apparatus comprising better display quality to meet the different needs of different consumers.

### SUMMARY OF THE INVENTION

It is an objective of the present invention to provide a display apparatus which is able to prevent the curved panel from color shift caused by the change of face and side optical characteristics due to the offsetting caused by the side-view transmittance curve.

To achieve the above, the present invention discloses a display apparatus includes a first substrate, a second substrate and a liquid crystal layer. The first substrate has a curved first side. The range of curvature radius of the first side is between 500 mm and 10000 mm. At least a datum line is defined on the first substrate. The included angle of the datum line and the first side is between 80 degrees and 100 degrees. The first substrate further comprises a plurality of pixel electrodes. A pixel electrode corresponding to a pixel area, and the pixel electrode has the substantially same voltage potential as an electric field being applied. The second substrate disposed opposite to the first substrate. The liquid crystal layer is disposed between the first substrate and the second substrate. The liquid crystal layer includes a plurality of liquid crystal molecules. The liquid crystal molecules in the pixel area corresponding to the datum line have a first tilt direction and a second tilt direction, and the first tilt direction and the second tilt direction are different.

In one embodiment, the range of the curvature radius is further between 2000 mm and 7500 mm.

In one embodiment, the included angle of the datum line and the first side is further between 85 degrees and 95 degrees.

In one embodiment, the included angle of the first tilt direction and the second tilt direction is between 170 degrees and 190 degrees.

In one embodiment, the liquid crystal molecules in the pixel area corresponding to the datum line further comprise a third tilt direction and a fourth tilt direction. The first tilt direction, the second tilt direction, the third tilt direction and the fourth tilt direction are different.

In one embodiment, the included angle of the first tilt direction and the second tilt direction, the included angle of the first tilt direction and the third tilt direction, and the included angle of the second tilt direction and the fourth tilt direction are between 80 degrees and 100 degrees, respectively.

In one embodiment, the pixel area is divided into 8 sub-pixel areas.

In one embodiment, the display apparatus further includes a polarizing element disposed on one side of the first substrate away from the second substrate. The included angle of absorption axis of polarizing element and the first tilt direction is between 35 degrees and 55 degrees.

In one embodiment, the display apparatus further includes a data line disposed corresponding to one of the pixel electrodes. The included angle of the data line and the datum line is between 170 degrees and 190 degrees on the projection orientation of the first substrate.

In one embodiment, the display apparatus further includes a light shield area disposed on the second substrate. The light shield area and the data line are overlaid on the projection orientation of the first substrate, and the included angle of the light shield area and the datum line is between 170 degrees and 190 degrees.

In one embodiment, the pixel electrode comprises an electrode pattern. The electrode pattern comprises a first trunk electrode, a second trunk electrode and a plurality of first branch electrodes, the included angle of the first trunk electrode and the second trunk electrode is between 80 degrees and 100 degrees, the included angle of the first trunk electrode and the datum line is between 170 degrees and 190 degrees, and the included angle of the first trunk electrode or the second trunk electrode and the first branch electrode is between 35 degrees and 55 degrees.

In one embodiment, the included angle of the first trunk electrode and the second trunk electrode is further between 85 degrees and 95 degrees, the included angle of the first trunk electrode and the datum line is further between 175 degrees and 185 degrees, and the included angle of the first trunk electrode or the second trunk electrode and the first branch electrode is further between 40 degrees and 50 degrees.

As mentioned above, according to the display apparatus of the present invention, the first substrate includes a curved first side. The range of the curvature radius of the first side is between 500 mm and 10000 mm. In addition, the included angle of the datum line and the first side is between 80 degrees and 100 degrees, and the liquid crystal molecules in the pixel area corresponding to the datum line include a first tilt direction and a second tilt direction which are different. In this way, variation ratio of the domains of the liquid crystal molecules in the pixel area corresponding to the pixel electrode may be the same, thus improving the problems of asymmetry perspective view of the display apparatus and preventing the curved display apparatus from color shift caused by the change of face and side optical characteristics due to the offsetting caused by the side-view transmittance curve.

### BRIEF DESCRIPTION OF THE DRAWINGS

FIG. 1A is a perspective view schematically showing a display apparatus according to a preferred embodiment of the present invention;

FIG. 1B is a sectional view showing a part of the display apparatus shown in FIG. 1A;

FIG. 1C is a side view showing a part of the first substrate shown in FIG. 1A;

FIG. 1D is a schematical view showing a pixel electrode and its corresponding pixel area in FIG. 1A;

FIG. 1E is a perspective view schematically showing a display apparatus according to another preferred embodiment of the present invention;

FIG. 1F and FIG. 1G are comparatively schematical view showing the first tilt direction and the second tilt direction according to different embodiments of the present invention;

FIG. 2A to FIG. 2N are schematical view showing the electrode pattern of the first pixel electrode of different embodiments;

FIG. 3A is a perspective view schematically showing a display apparatus according to another preferred embodiment of the present invention;

FIG. 3B is a sectional view showing a part of the display apparatus shown in FIG. 3A;

FIG. 3C is a side view showing a part of the first substrate shown in FIG. 3A;

FIG. 3D is a top view schematically showing the display apparatus shown in FIG. 3A; and

FIG. 3E is a schematical view showing a pixel electrode and its corresponding pixel area in FIG. 3A.

### DETAILED DESCRIPTION OF THE INVENTION

The present invention will be apparent from the following detailed description, which proceeds with reference to the accompanying drawings, wherein the same references relate to the same elements.

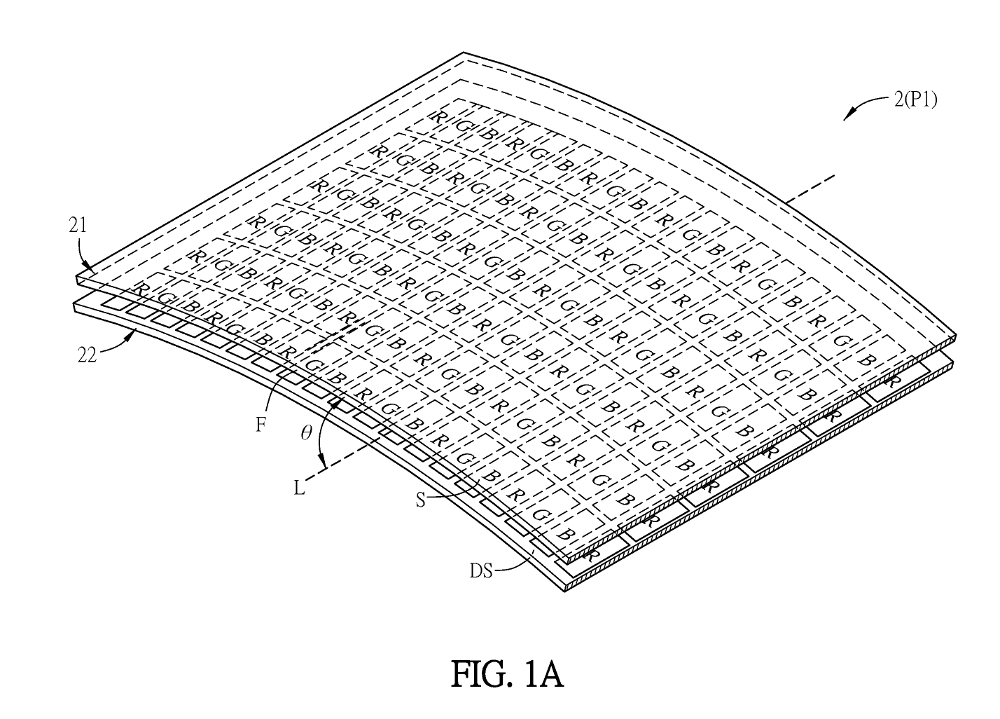

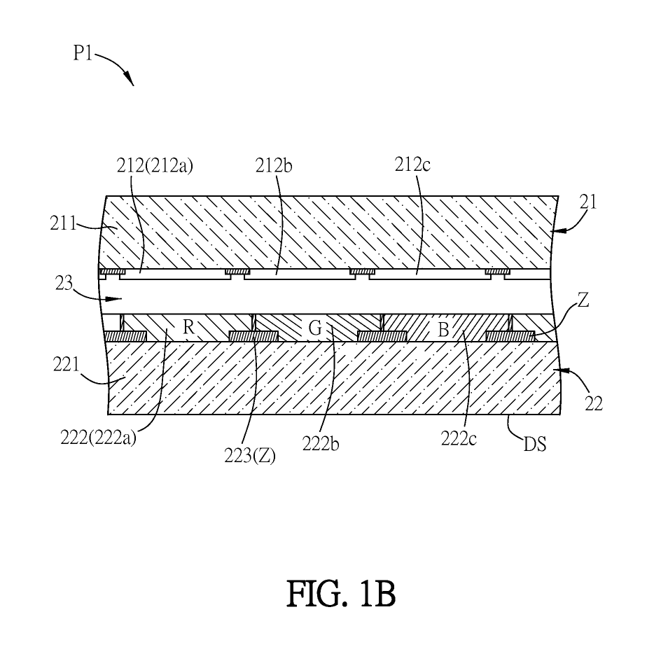

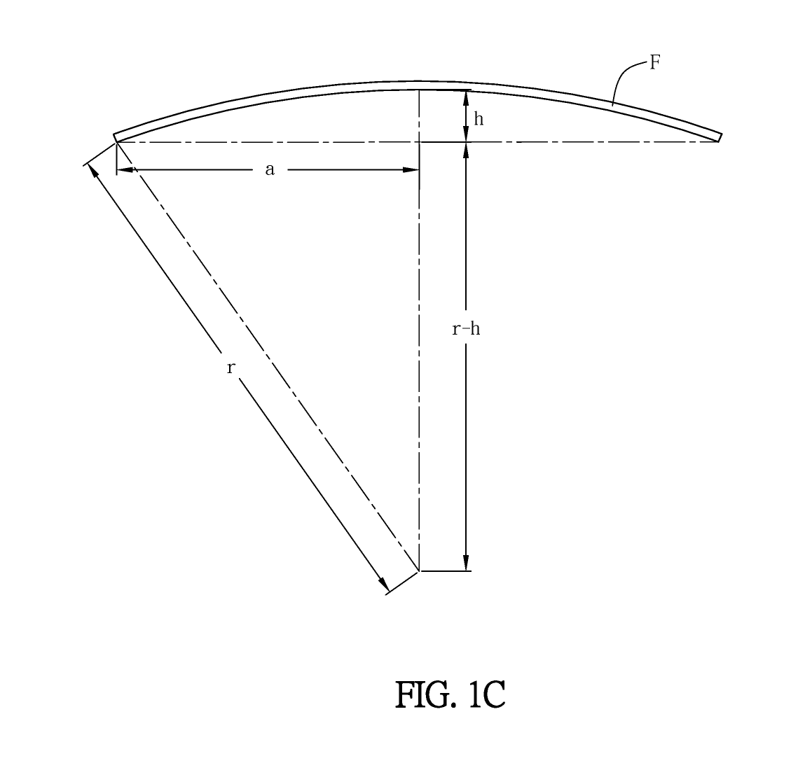

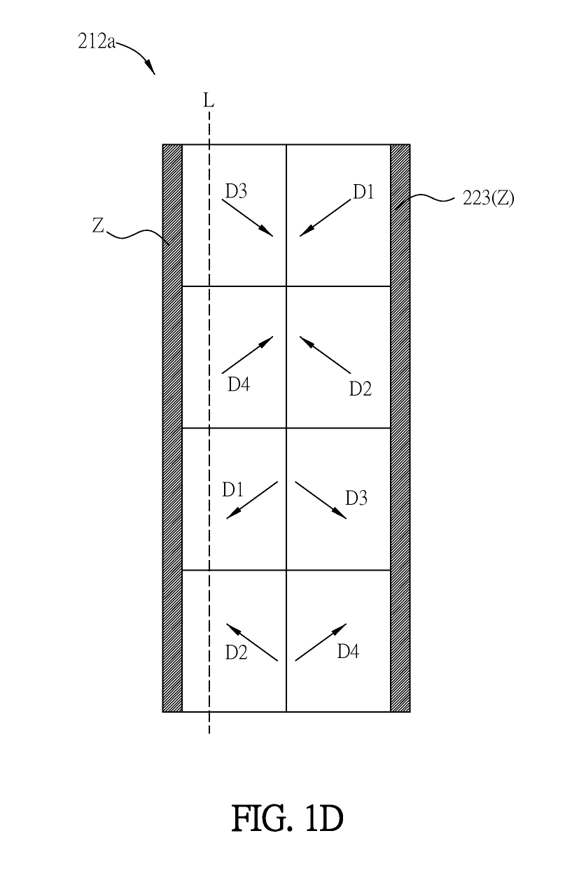

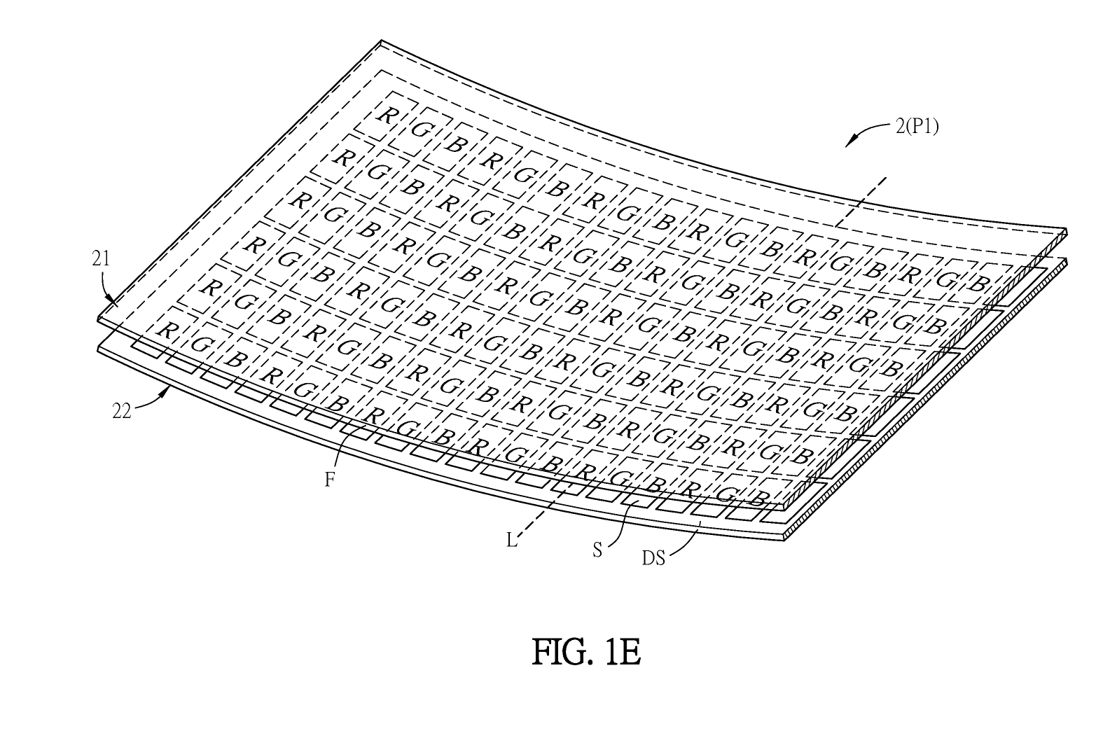

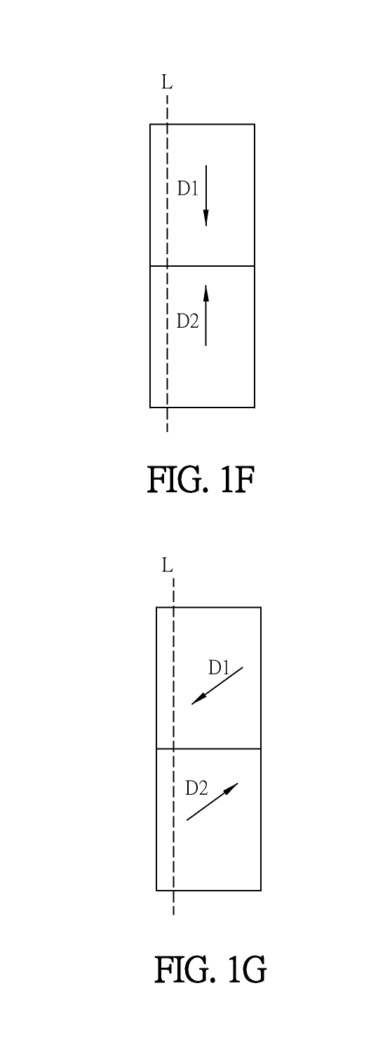

With reference to FIG. 1A to FIG. 1D, FIG. 1A is a perspective view schematically showing a display apparatus 2 according to a preferred embodiment of the present invention. FIG. 1B is a sectional view showing a part of the display apparatus shown in FIG. 1A. FIG. 1C is a side view showing a part of the first substrate 21 shown in FIG. 1A. FIG. 1D is a schematical view showing a pixel electrode and its corresponding pixel area in FIG. 1A.

The display apparatus 2 of the present embodiment is based on a liquid crystal device with curved shape as an example. As shown in FIG. 1A, said “curved” means the display apparatus 2 includes bending display panel P1 having a bending display surface DS. Viewers are able to watch the images shown by the display apparatus 2 from the display surface DS. The display surface DS may be a cambered surface having a curvature radius, or several cambered surfaces (like wavy) having several curvature radiuses. In other words, while laterally watching the display panel P1, the two sides of the display panel P1 are more curved or more lifted than the central part of the display panel P1. Or in the other embodiment, the display surface may be wave-shaped which is not for limitation. It is worth mentioning that the curved display panel P1 of the present invention is manufactured form a flat display panel by any means in the manufacture procedure, thus finalizing a display panel P1 with a curved panel before leaving factory.

As shown in FIG. 1A, in this embodiment, the display surface DS is disposed under the display panel P1. The two sides of the display panel P1 bends toward the viewer's direction; hence, compared to the two sides of the display panel, the central part of the display panel is farther to the front viewers. The display surface DS is a curved surface in this embodiment. However, in other embodiment (as shown in FIG. 1E) the two sides of the display panel P1 are able to bent toward the direction away from the viewers, making the two sides of the display panel P1 are farther to the viewers while comparing to the central part of the display panel P1, which is not for limitation. Please referred to FIG. 1A, the display panel P1 in FIG. 1A appears a square shape (rectangular shape), though it is actually a curved display panel. The display panel P1 merely shows the alignment of a red color filter R, a green color filter G and a blue color filter B. Other elements of display panel P1 are not shown in FIG. 1A. In addition, since the display apparatus 2 is a curved-type device, it has a curved first substrate 21 including a curved first side F as shown in FIG. 1A. As watching from the side direction perpendicular to the curved first side F of the first substrate 21, the curved first side F has a curvature radius r. The range of the curvature radius r of the present embodiment is limited between 500 mm and 10000 mm (500≦r≦10000). Preferably, the range of the curvature radius r is between 2000 mm and 7500 mm (2000≦r≦7500). FIG. 1C only shows a part of the first substrate 21, and the formula of the curvature radius r can be obtained by Pythagorean theorem. Hence, as shown in FIG. 1C, the formula of the curvature radius r is r=(a²+h²)/2h, 0<a≦1 cm. The curved first side F of the curved first substrate 21 of this embodiment includes one curvature radius r (i.e. curved display panel P1).

In addition, the display panel P1 of the display apparatus 2 includes a first substrate 21, a second substrate 22 and a liquid crystal layer 23 (not shown in FIG. 1A, liquid crystal layer 23 may be referred to FIG. 1B). The first substrate 21 and the second substrate 22 is made of light transmissible materials. For example, the first substrate 21 is a glass substrate, a quartz substrate, or a plastic substrate, which is not for limitation. Otherwise, the display apparatus 2 further includes a backlight module (not shown). The backlight module is disposed on the side of the display panel P1 away from the display surface DS (i.e. the upper side of the display panel P1 shown in FIG. 1A). The backlight module illuminate through the display panel P1, thus generating an image with the pixels on the display panel P1.

The first substrate 21 further includes a surface S facing the second substrate 22. At least a datum line L is defined on the first substrate 21. In this embodiment, one datum line is taken for example. The datum line which is a virtual straight line is located between and across the first substrate 21 and the second substrate 22. Hence, as looking up the display panel P1, the datum line is located on the surface S of the first substrate 21. In addition, as shown in FIG. 1B, the first substrate includes a first transparent substrate 211 and a plurality of pixel electrodes 212. The pixel electrodes 212 which are transparent conductive electrodes are disposed on one side of the first transparent substrate 211 facing the second substrate 22. The pixel electrodes 212 include, for example, a first pixel electrode 212a, a second pixel electrode 212b and a third pixel electrode 212c. A pixel electrode is corresponding to a pixel area. First pixel electrode 212a (or the second pixel electrode 212b, or the third pixel electrode 212c) includes at least one voltage potential while an electric field is applied.

The second substrate 22 includes a second transparent substrate 221 and a filter layer 222. The filter layer includes several color filters comprising a red color filter 222a (R), a green color filter 222b (G) and a blue color filter 222c (B). The material of the red color filter 222a, the green color filter 222b and the blue color filter 222c is light transmissive material, like pigment or dye. Those filter portions can be aligned in a matrix arrangement on the first transparent substrate 211 by dyeing method, pigment dispersed method, printing method, dry film method or electro-deposition method. Herein, the filter layer 222 is not limited to the red color filter 222a, the green color filter portion 222b and the blue color filter 222c. Other color, like cyan-blue, is located on one side of the second transparent substrate 221 facing the first substrate.

The second substrate further includes a black matrix 223. The black matrix is disposed on the second transparent substrate 221, and the filter layer 222 is disposed on the second transparent substrate 221 and the black matrix 223. The black matrix 223 is a non-transparent material, e.g. metal or resin. The metals such as chromium, chromium oxide or nitrogen oxide chromium compounds can be applied. Since the black matrix 223 is a non-transparent material, it is able to define a plurality of light transmissive area on the second substrate 22. The black matrix 223 includes a plurality of light shield areas Z. And the light shield area is existed between two adjacent color filters (e.g. there is a light shield area Z existing between the red color filter 222a and the green color filter 222b and between the green color filter 222b and the blue color filter portion 222c as shown in FIG. 1B). In this embodiment, the first substrate 21 is a thin-film transistor (TFT) substrate, and the second substrate 22 is a color filter substrate. In other embodiment, the black matrix 223 and the filter layer 222 on the color filter substrate can be disposed on the thin-film transistor substrate, making the first substrate 21 become a BOA (BM on array) substrate or a COA (color filter on array) substrate, which is not limited for the present invention. In addition, the second substrate 22 further includes a protective layer (not shown). The protective layer is able to cover the filter layer 222. The material of the protective layer may be a photoresist material, a resin material or an inorganic material (e.g. SiOx/SiNx) to prevent the filter layer 222 from being destroyed by the subsequent process.

With reference to FIG. 1A, as watching from the projection direction of the display apparatus 2 (the first substrate 21), the included angle θ of the datum line L and the first side F is between 80 and 100 degrees (90±10). Preferably, the included angle θ of the datum line L and the first side F may be further between 85 degrees and 95 degrees (90±5). In other words, the left and right side of the display panel P1 of the display apparatus 2 bent toward the display surface DS (the lower side of the FIG. 1A). The virtual bending axis of the datum line L and the display panel P1 is almost parallel to each other (the virtual bending axis is located across the central part of the display panel P1 in FIG. 1A). Thus, while watching from the projection direction of the display apparatus 2 (the first substrate 21), the datum line L and the first side F of the first substrate 21 includes an included angle θ which is between 80 degrees and 100 degrees (when the included angle θ is 90 degrees, it means the two elements are perpendicular to each other). Preferably, the included angle θ is between 85 degrees and 95 degrees.

In addition, the datum line L is corresponding to each pixel electrode 212. Take the first pixel electrode 212a for example, in FIG. 1D, each liquid crystal molecule in the pixel area corresponding to the first pixel electrode 212a, which is corresponding to the datum line L, has a first tilt direction D1 and a second tilt direction D2 respectively, and the first tilt direction D1 and the second tilt direction D2 are different from each other. In one embodiment, as shown in FIG. 1F or FIG. 1G, the included angle of the first tilt direction D1 and the second tilt direction D2 is between 170 degrees and 190 degrees (170 included angle 190), when the included angle is 180 degrees, it means the two tilt directions are opposite directions. In addition, in this embodiment, as shown in FIG. 1D, the liquid crystal molecules in the pixel area corresponding to the first pixel electrode 212a, which is corresponding to the datum line L, further has a third tilt direction D3 and a fourth tilt direction D4 respectively. Wherein, the first tilt direction D1, the second tilt direction D2, the third tilt direction D3 and the fourth tilt direction D4 are different (4 domains). Otherwise, the included angle of the first tilt direction D1 and the second tilt direction D2, the included angle of the first tilt direction D1 and the third tilt direction D3, and the included angle of the second tilt direction D2 and the fourth tilt direction D4 are between 80 degrees and 100 degrees (80≦included angle≦100), respectively. Preferably, the included angle mentioned above may be further between 85 degrees and 95 degrees (85≦included angle≦95). Therefore, variation ratio of the liquid crystal molecules in the pixel area corresponding to the first pixel electrode 212a in 4 domains may be the same for improving the problems of asymmetry perspective view of the display apparatus 2 and preventing the curved display apparatus 2 from color shift caused by the change of face and side optical characteristics due to the offsetting caused by the side-view transmittance curve.

In other words, in the display apparatus 2 of the present embodiment, the pixel electrode 212 is divided into 8 electrode areas. The liquid crystal molecules corresponding to the 8 electrode areas are further divided into two sections along the datum line L. As shown in FIG. 1D, along the direction of the datum line L, the liquid crystal molecules in the left section of the electrode area are dispersed in 4 tilt directions D1, D2, D3, D4, and the liquid crystal molecules in the right section of the electrode area are also dispersed in 4 tilt directions D1, D2, D3, D4. As shown in FIG. 1B and FIG. 1D, when the display panel P1 is bent to make the dislocation of the first substrate 21 and the second substrate 22, the offsetting of the black matrix 223 makes the 4 domains of the pixel electrode 212 have the same variation ratio along the datum line L. Hence, the side-view transmittance curve of the display panel P1 may not have much change, thus preventing the curved display apparatus 2 from color shift caused by the change of face and side optical characteristics. The order of the tilt directions D1, D2, D3, D4 is not limited. The order may be random alignment, such as D2, D3, D4, D1 or D1, D3, D4, D2. In addition, the included angle of the first tilt direction D1 and the second tilt direction D2 is between 80 degrees and 100 degrees, preferably between 85 degrees and 95 degrees. The included angle of the first tilt direction D1 and the third tilt direction D3 is between 80 degrees and 100 degrees, preferably between 85 degrees and 95 degrees. And the included angle of the second tilt direction D2 and the fourth tilt direction D4 is between 80 degrees and 100 degrees, preferably between 85 degrees and 95 degrees. In this embodiment, 0 degree is set to be horizontally to the right, and the first tilt direction D1 is 225 degrees, the second tilt direction D2 is 135 degrees, the third tilt direction D3 is 45 degrees, and the fourth tilt direction D4 is 45 degrees. These included angles are azimuth angles of the slanting liquid crystal molecules.

In addition, the display apparatus further includes a first polarizing element (not shown in figure). The first polarizing element is disposed on one side of the first substrate 21 away from the second substrate 22 (the upper side of the first substrate 21 in FIG. 1B). The first polarizing element is a polarizing film, and the included angle of its absorption axis and the first tilt direction D1 is between 35 degrees and 55 degrees. Preferably, the included angle is between 40 degrees and 50 degrees. Otherwise, the display apparatus 2 further includes a second polarizing element (not shown in figure). The second polarizing element is disposed on one side of the second substrate 22 away from the first substrate 21 (the bottom side of the second substrate 22 in FIG. 1B). The second polarizing element is also a polarizing film, and the included angle of its absorption axis and the first tilt direction D1 is between 125 degrees and 145 degrees. Preferably, the included angle is between 85 degrees and 95 degrees (The absorption axes of the first polarizing element and the second polarizing element have 90 degrees difference).

The display apparatus 2 further includes a data line (not shown in figure). The data line is disposed opposite and electrically connected to the first pixel electrode 212a. On the projection direction of the first substrate 21, the included angle of the data line and the datum line L is between 170 degrees and 190 degrees (when the included angle is 180 degrees, the data line is parallel to the datum line L). Preferably, the included angle of the two elements may be further between 175 degrees and 185 degrees. Otherwise, on the projection direction of the first substrate 21, the light shield area Z of the black matrix 232 overlays the data line, and the included angle of the light shield area Z and the datum line L is between 170 degrees and 190 degrees (when the included angle is 180 degrees, the light shield area Z is parallel to the datum line L). Preferably, the included angle is between 175 degrees and 185 degrees.

In order to make the liquid crystal corresponding to the 8 electrode areas of the first pixel electrode 212a have 4 different tilt directions D1, D2, D3, D4, the liquid crystal molecules are applied voltage and exposure to UV radiation as a plurality of light reactive monomers being mixed into the liquid crystal molecules. After the process, the light reactive monomers in the liquid crystal would become hardening, and the hardening monomer will align in the arrangement of the electrode pattern of the first pixel electrode 212a of the first substrate 21 in order to make the liquid crystal molecules to have proper orientation, further increasing the view angles of the display apparatus 2. In other embodiment, the alignment layer (e.g. polyimide, PI) of the first substrate or the second substrate may be processed by polarized light in order to make the alignment layer to undergo inhomogeneous photopolymerization, isomerization or cracking, which induced the chemical bond structure of the alignment layer to generate special orientation and further induced the liquid crystal molecule to align forward orientation.

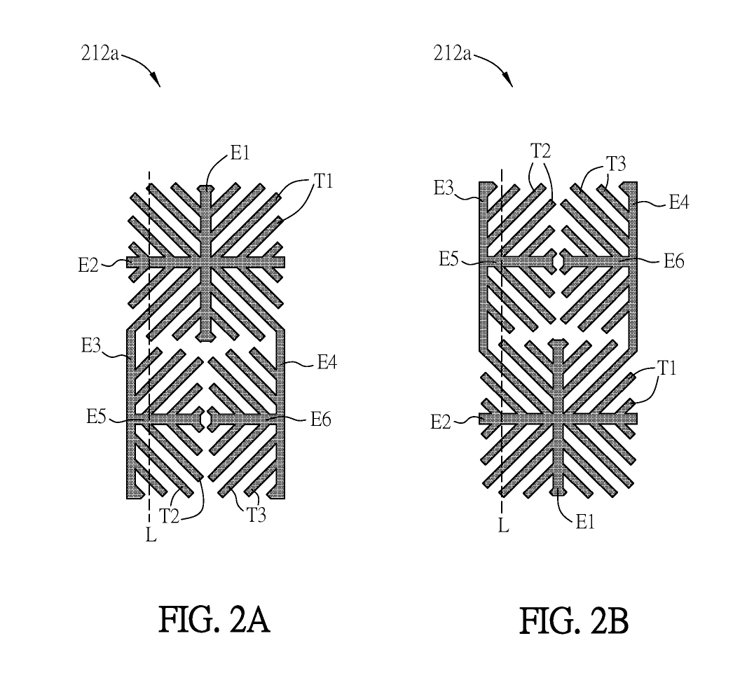

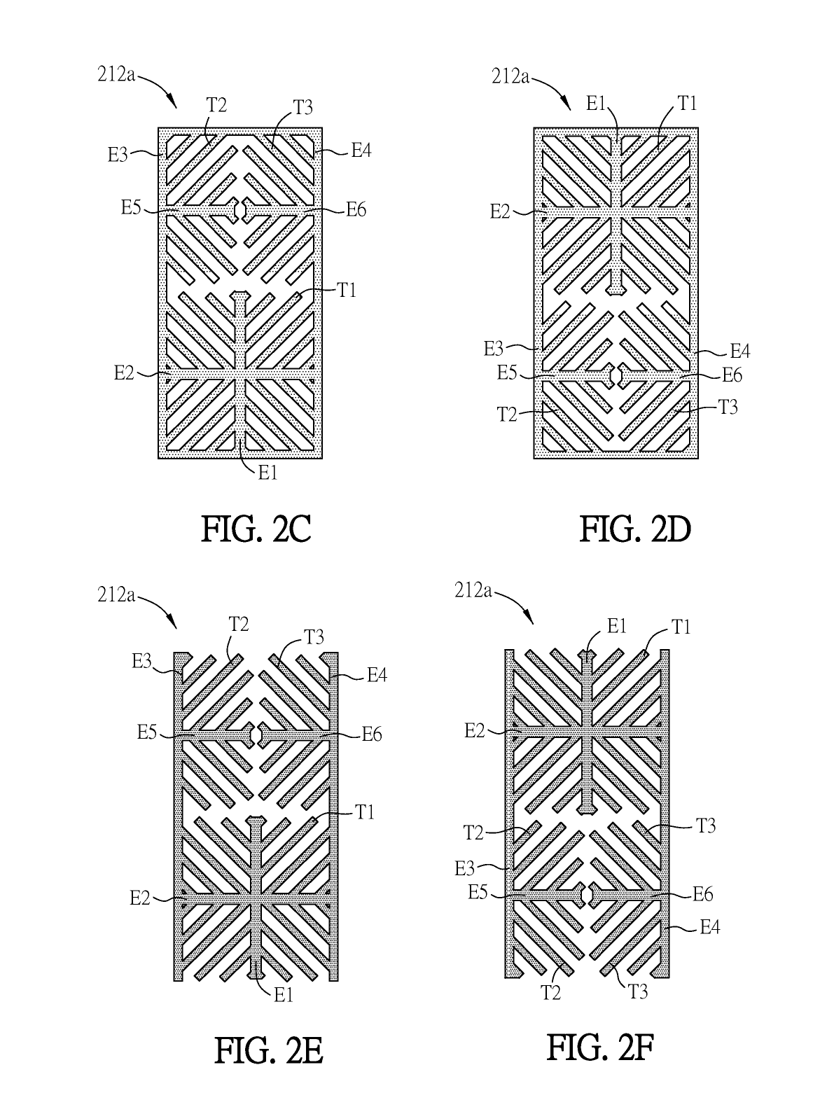

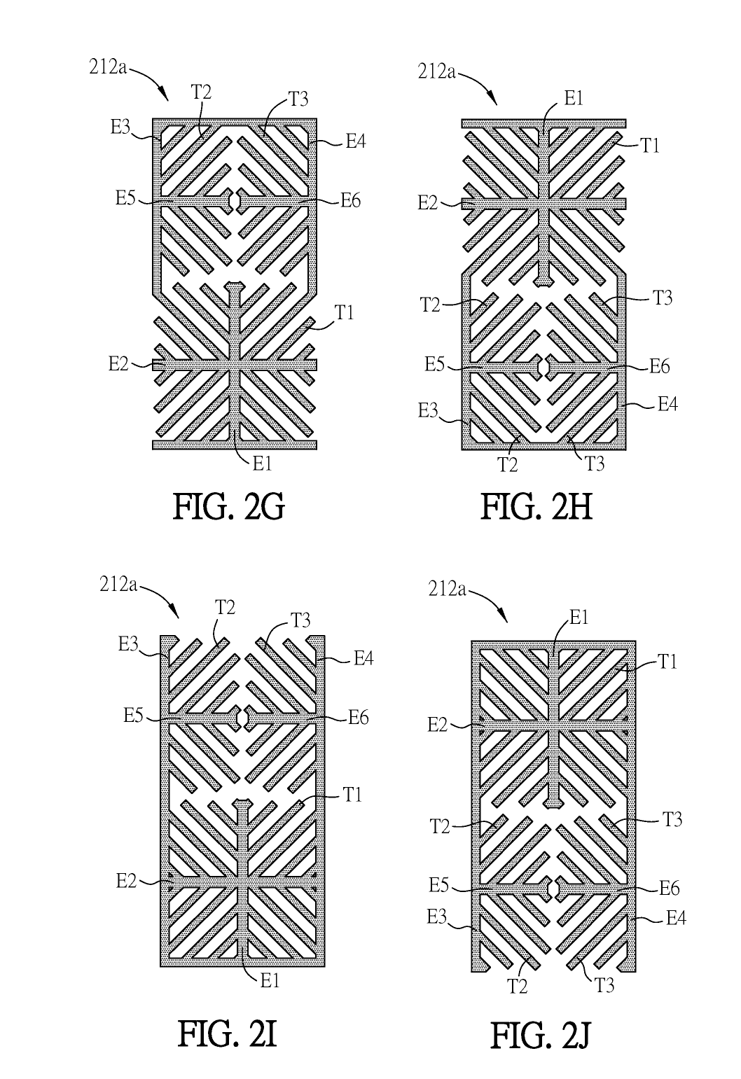

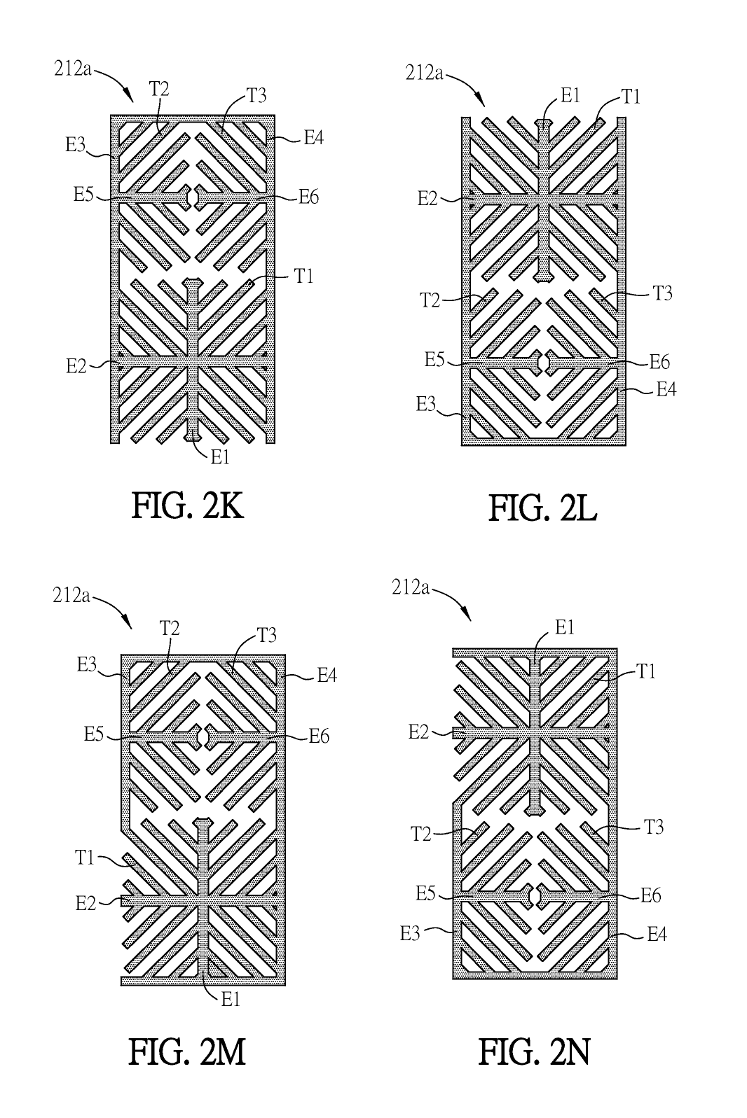

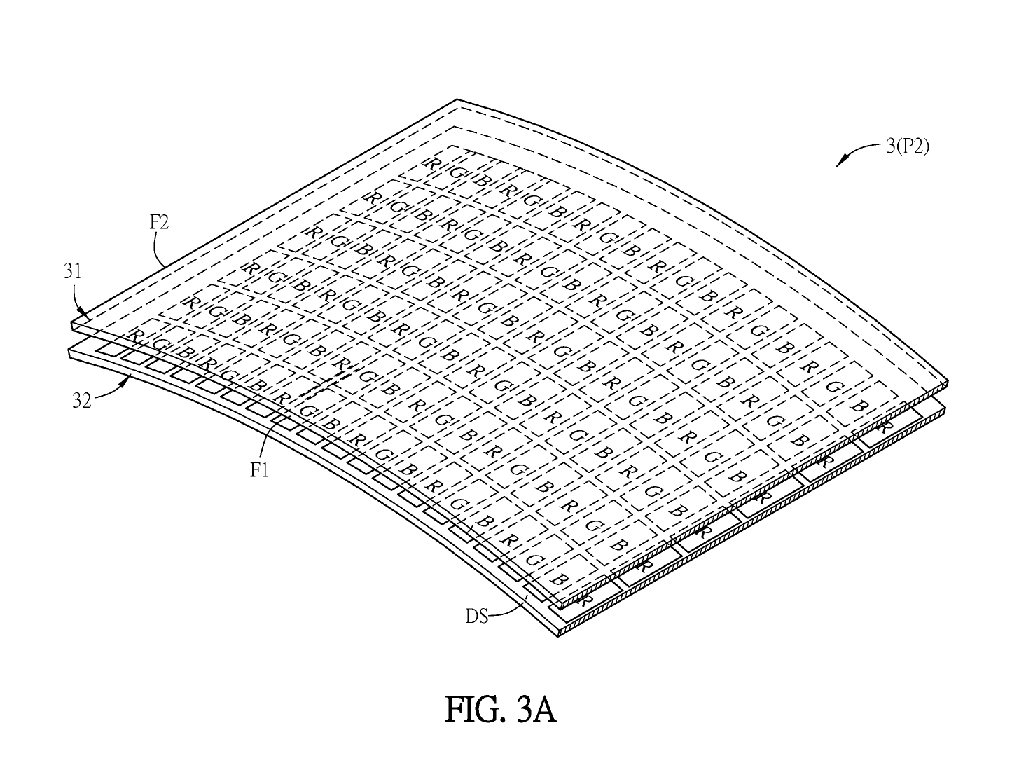

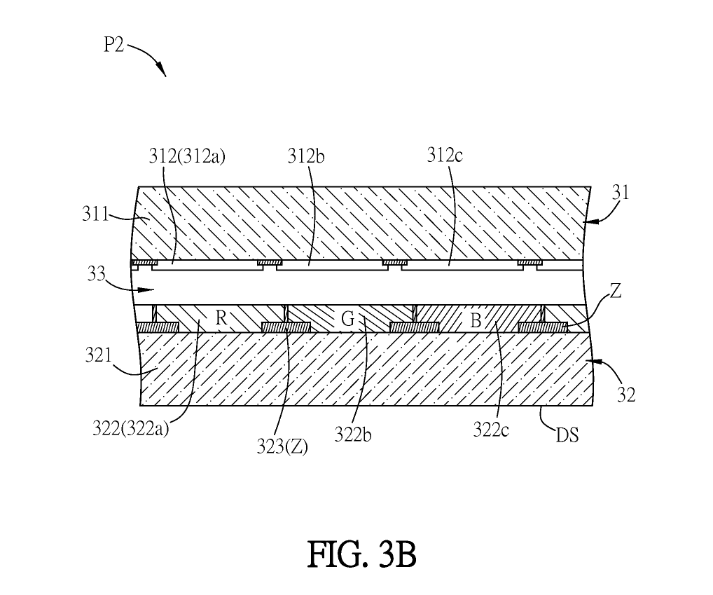

With reference to FIG. 2A to FIG. 2N, these figures show different embodiment of the electrode pattern of the first pixel electrode 212a. Through the pattern of the first pixel electrode in FIG. 2A to FIG. 2N, the purpose of orientation for liquid crystal molecules can be achieved by hardening the light reactive monomers. FIG. 2A to FIG. 2N shows different electrode patterns of the first pixel electrode 212a in different embodiment. It can also represent the electrode pattern of every pixel electrode 212.

As shown in FIG. 2A, the first pixel electrode 212a includes an electrode pattern comprising a first trunk electrode E1, a second trunk electrode E2 and a plurality of first branch electrode T1. The included angle of the first trunk electrode E1 and the second trunk electrode E2 is between 80 degrees and 100 degrees, preferably between 85 degrees and 95 degrees. The included angle between the first trunk electrode E1 and the datum line L is between 170 degrees and 190 degrees, preferably between 175 degrees and 185 degrees. The included angle of the second trunk electrode E2 and the datum line L is between 80 degrees and 100 degrees, preferably between 85 degrees and 95 degrees. The included angle of the first trunk electrode E1 or the second trunk electrode E2 and the first branch electrode T1 is between 35 degrees and 55 degrees, preferably between 40 degrees and 50 degrees.

In addition, the electrode pattern of the first pixel electrode 212a further includes a third trunk electrode E3, a fourth trunk electrode E5, a sixth trunk electrode E6, a plurality of second branch electrodes T2 and a plurality of third branch electrodes T3. The included angle of the third trunk electrode E3 and the datum line L, and the included angle of the fourth trunk electrode E4 and the datum line L are between 170 degrees and 190 degrees, preferably between 175 degrees and 185 degrees. The included angle of the fifth trunk electrode E5 and the datum line L, and the included angle of the sixth trunk electrode E6 and the datum line L are between 80 degrees and 100 degrees, preferably between 85 degrees and 95 degrees. The included angle of the third trunk electrode E3 and the fifth trunk electrode E5 is between 80 degrees and 100 degrees, preferably between 85 degrees and 95 degrees. The included angle of the fourth trunk electrode E4 and the sixth trunk electrode E6 is between 80 degrees and 100 degrees, preferably between 85 degrees and 95 degrees. The included angle of the third trunk electrode E3 and each second branch electrode T2, or the included angle of the fifth trunk electrode E5 and each second branch electrode T2 is between 35 degrees and 55 degrees, preferably between 40 degrees and 50 degrees. The included angle of the fourth trunk electrode E4 and each third branch electrode T3, or the included angle of the sixth trunk electrode E6 and each third branch electrode T3 is between 35 degrees and 55 degrees, preferably between 40 degrees and 50 degrees.

FIG. 2B is a 180 degrees rotational view of FIG. 1A (upside down). Its trunk electrode and branch electrode can be referred to the above mentioned contents, and is not repeated here. Otherwise, compared to FIG. 2A or FIG. 2B, FIG. 2C to FIG. 2N have a small change on the peripheral portion of the electrode pattern of FIG. 2A or FIG. 2B. Designers may be able to comprehend its layout according to the figures and the contents mentioned above, and are not repeated here. The electrode pattern of the first pixel electrode 212a is an example, and is not for limitation.

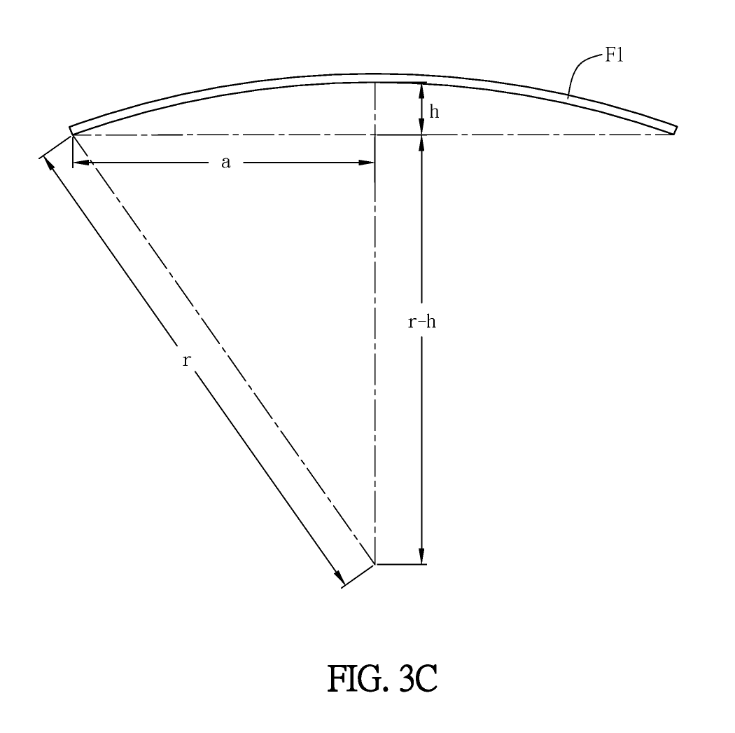

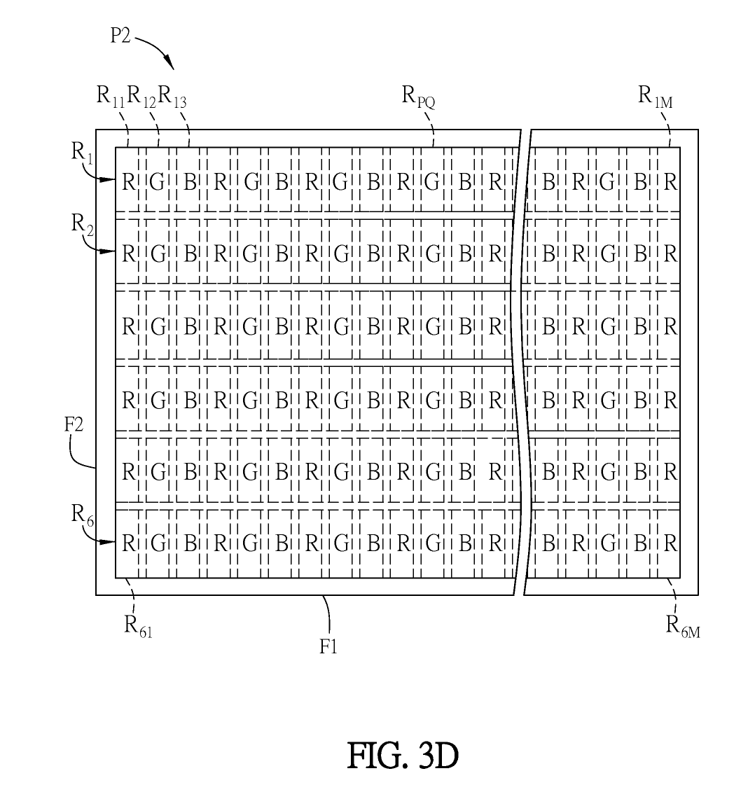

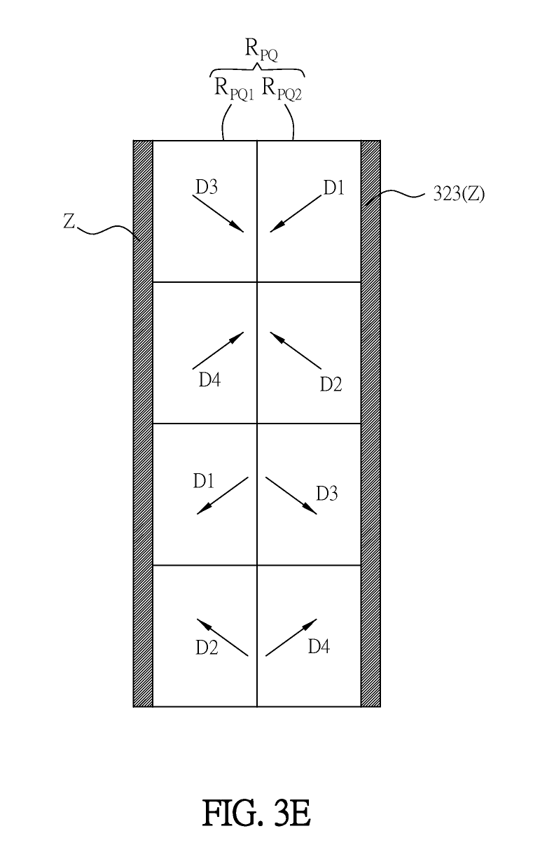

With reference to FIG. 3A to FIG. 3E, FIG. 3A is a perspective view schematically showing a display apparatus according to another preferred embodiment of the present invention, FIG. 3B is a sectional view showing a part of the display apparatus shown in FIG. 3A, FIG. 3C is a side view showing a part of the first substrate shown in FIG. 3A, FIG. 3B is a top view schematically showing the display apparatus shown in FIG. 3A, FIG. 3E is a schematical view showing a pixel electrode and its corresponding pixel area in FIG. 3A.

The display apparatus 3 of the present embodiment takes a liquid crystal display apparatus for example, and it could be a curved liquid crystal display apparatus. As shown in FIG. 3A, said “curved” means the display apparatus 3 includes a bending display panel P2 having a bending display surface DS. Viewers are able to watch the images shown in display apparatus 3 form the display surface DS. The display surface DS may be a cambered surface having a curvature radius, or several cambered surfaces (like wavy) having several curvature radiuses. In other words, while laterally watching the display panel P2, the two sides of the display panel P2 are more curved or more lifted than the central part of the display panel P2. Or in the other embodiment, the display surface DS may be wave-shaped which is not for limitation. It is worth mentioning that the curved display panel P2 of the present invention is manufactured form a flat display panel by any means in the manufacture procedure, thus finalizing a display panel P2 with a curved panel before leaving factory.

As shown in FIG. 3A, in this embodiment, the display surface DS is disposed under the display panel P2. The two sides of the display panel P2 bends toward the viewer's direction; hence, compared to the two sides of the display panel, the central part of the display panel is farther to the front viewers. The display surface DS is a curved surface in this embodiment. However, in other embodiment the two sides of the display panel P2 are able to bend toward the direction away from the viewers, making the two sides of the display panel P2 are farther to the viewers while comparing to the central part of the display panel P2, which is not for limitation. Please referred to FIG. 3A in top view, the display panel P2 in FIG. 3D appears a square shape (rectangular shape), though it is actually a curved display panel. In addition, since the display apparatus 3 is a curved-type apparatus, it has a curved first substrate 31 including a curved first side F1 as shown in FIG. 3A. As watching from the side direction perpendicular to the curved first side F1 of the first substrate 31, the curved first side F1 has a curvature radius r. The range of the curvature radius r of the present embodiment is limited between 500 mm and 10000 mm (500≦r≦10000). Preferably, the range of the curvature radius r is between 2000 mm and 7500 mm (2000≦r≦7500). FIG. 3C only shows a part of the first substrate 31, and the formula of the curvature radius r can be obtained by Pythagorean theorem. Hence, as shown in FIG. 3C, the formula of the curvature radius r is r=(a²+h²)/2h, 0<a≦1 cm. The curved first side F1 of the curved first substrate 31 of this embodiment includes one curvature radius r (i.e. curved display panel P2).

In addition, the display panel P2 further includes a second substrate 32 and a liquid crystal layer 33 (not shown in FIG. 3A, liquid crystal layer 33 may be referred to FIG. 3B). The first substrate 31 and the second substrate 32 are disposed opposite to each other. The liquid crystal layer 33 is disposed between the first substrate 31 and the second substrate 32, and the liquid crystal layer 33 includes a plurality of liquid crystal molecules. The first substrate 31 and the second substrate 32 is made of light transmissible materials. For example, the first substrate 31 is a glass substrate, a quartz substrate, or a plastic substrate, which is not for limitation. Otherwise, the display apparatus 3 further includes a backlight module (not shown in figure). The backlight module is disposed on the side of the display panel P2 away from the display surface DS (i.e. the upper side of the display panel P2 shown in FIG. 3A). The backlight module illuminate through the display panel P2, thus generating an image with the pixels on the display panel P2.

As shown in FIG. 3B, the first substrate 31 includes a first transparent substrate 311 and a plurality of pixel electrodes 312. The pixel electrodes 312 which are transparent conductive electrodes are disposed on one side of the first transparent substrate 311 facing the second substrate 32. For example, the pixel electrodes 312 include a first pixel electrode 312a, a second pixel electrode 312b and a third pixel electrode 312c. A pixel electrode is corresponding to a pixel area. The pixel electrode 312 (e.g. the first pixel electrode 312a, the second pixel electrode 312b, or the third pixel electrode 312c) has the substantially same electric potential while an electric field is applied to the display panel P2.

The second substrate 32 includes a second transparent substrate 321 and a filter layer 322. The filter layer includes several color filters comprising a red color filter 322a (R), a green color filter 322b (G) and a blue color filter 322c (B). The material of the red color filter 322a, the green color filter 322b and the blue color filter 322c is light transmissive material, like pigment or dye. Those color filters can be aligned in a matrix arrangement on the first transparent substrate 311 by dyeing method, pigment dispersed method, printing method, dry film method or electro-deposition method. Herein, the filter layer 322 is not limited to the red color filter 322a, the green color filter 322b and the blue color filter 322c. Other color, like cyan-blue, is located on one side of the second transparent substrate 321 facing the first substrate 31.

The second substrate 32 further includes a black matrix 323. The black matrix 323 is disposed on the second transparent substrate 321, and the filter layer 322 is disposed on the second transparent substrate 321 and the black matrix 323. The black matrix 323 is a non-transparent material, e.g. metal or resin. And metals such as chromium, chromium oxide or nitrogen oxide chromium compounds can be applied. Since the black matrix 323 is a non-transparent material, it is able to define a plurality of light transmissive area on the second substrate 32. The black matrix 323 includes a plurality of light shield areas Z. And the light shield area Z is existed between two adjacent color filters (e.g. there is a light shield area Z existing between the red color filter 322a and the green color filter portion 322b and between the green color filter 322b and the blue color filter 322c). In this embodiment, the first substrate 31 is a thin-film transistor (TFT) substrate, and the second substrate 32 is a color filter substrate. In other embodiment, the black matrix 323 and the filter layer 322 on the color filter substrate can be disposed on the thin-film transistor substrate, making the first substrate 31 become a BOA (BM on array) substrate or a COA (color filter on array) substrate, which is not limited for the present invention. In addition, the second substrate 32 further includes a protective layer (not shown in figure). The protective layer is able to cover the filter layer 322. The material of the protective layer may be a photoresist material, a resin material or an inorganic material (e.g. SiOx/SiNx) to prevent the filter layer 322 from being destroyed by the subsequent processes.

As shown in FIG. 3D, the display panel P2 further includes a plurality of pixel rows R₁˜R_{N} (FIG. 3D only shows 6 pixel rows R₁˜R₆ for example). The pixel rows R₁˜R_{N} are disposed on the first substrate 31, aligned along the extension direction of the second side F2 adjacent to the first side F1 on the first substrate 31. Each pixel row includes a plurality of pixel areas. A pixel area corresponds to a pixel electrode 312 including an electrode figure and corresponding to a plurality of liquid crystal molecules. Take pixel row R₁ as an example, pixel row R₁ has a plurality of pixel areas R₁₁˜R_{1M}. A pixel area corresponds to a pixel electrode 312 and its electrode pattern. Each pixel areas R₁₁˜R_{1M} is divided into a first row sub-pixel area and a second row sub-pixel area. For example (as shown in FIG. 3E), the pixel area R_{PQ} (1≦P≦N, 1≦Q≦M) is divided into a first row sub-pixel area R_{PQ1} and a second row sub-pixel area R_{PQ2}. The first row sub-pixel area R_{PQ1} is closer to the second side F2, and the second row sub-pixel area R_{PQ2} is further away from the second side F2. The first row sub-pixel area R_{PQ1} and the second row sub-pixel area R_{PQ2} are divided separately to obtain the same amount of sub-pixel areas (FIG. 3E shows 8 sub-pixel areas).

The liquid crystal molecules corresponded with the first row sub-pixel area R_{PQ1} and the second row sub-pixel area R_{PQ2} include a first tilt direction D1, a second tilt direction D2, the third tilt direction D3 and the fourth tilt direction D4 which are different (4 domains). These four tilt direction D1, D2, D3, D4 corresponds to 4 sub-pixel areas respectively. The included angle of the first tilt direction D1 and the second tilt direction D2, the included angle of the first tilt direction D1 and the third tilt direction D3, and the included angle of the second tilt direction D2 and the fourth tilt direction D4 are between 80 degrees and 100 degrees, respectively. Preferably, the included angle mentioned above may be further between 85 degrees and 95 degrees. In this way, variation ratio of the liquid crystal molecules in the pixel area corresponding to the pixel electrode in 4 domains may be the same, thus improving the problems of asymmetry perspective view of the display apparatus 3 and preventing the curved display apparatus 3 from color shift caused by the change of face and side optical characteristics due to the offsetting caused by the side-view transmittance curve. In this embodiment, 0 degree is set to be horizontally to the right, and the first tilt direction D1 is 225 degrees, the second tilt direction D2 is 135 degrees, the third tilt direction D3 is 45 degrees, and the fourth tilt direction D4 is 45 degrees.

In other words, in the display apparatus 3 of this embodiment, each pixel area R_{PQ} is divided into a first row sub-pixel area R_{PQ1} and a second row sub-pixel area R_{PQ2}. The liquid crystal molecules corresponding to the first row sub-pixel area R_{PQ1} includes 4 tilt directions D1, D2, D3, D4, and the liquid crystal molecules corresponding to the second row sub-pixel area R_{PQ2} also includes 4 tilt directions D1, D2, D3, D4. Hence, as shown in FIG. 3B and FIG. 3E, when the display panel P2 is bent to make the dislocation of the first substrate 31 and the second substrate 32, the offsetting of the black matrix 323 makes the 4 domains of the first row sub-pixel area R_{PQ1} and the second row sub-pixel area R_{PQ2} of each pixel area R_{PQ} have the same variation ratio along the datum line L. Hence, the side-view transmittance curve of the display panel P2 may not have much change, thus preventing the curved display apparatus 3 from color shift caused by the change of face and side optical characteristics.

In addition, the display panel P2 of the display apparatus 3 may further includes 2 polarizing elements, a plurality of data lines and a plurality of pixel electrodes. The technical characteristics of the polarizing elements, the data lines, the pixel electrodes and their electrode pattern can be referred to the elements of the display panel P1, and is not repeated here.

As mentioned above, according to the display apparatus of the present invention, the first substrate includes a curved first side. The range of the curvature radius of the first side is between 500 mm and 10000 mm. In addition, the included angle of the datum line and the first side is between 80 degrees and 100 degrees, and the liquid crystal molecules in each pixel area corresponding to the datum line include a first tilt direction and a second tilt direction which are different. In this way, variation ratio of the domains of the liquid crystal molecules in the pixel area corresponding to the pixel electrode may be the same, thus improving the problems of asymmetry perspective view of the display apparatus and preventing the curved display apparatus from color shift caused by the change of face and side optical characteristics due to the offsetting caused by the side-view transmittance curve.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display apparatus comprising:
a first substrate having a curved first side, wherein the range of curvature radius of the first side is between 500 mm and 10000 mm, at least a datum line is defined on the first substrate, the included angle of the datum line and the first side is between 80 degrees and 100 degrees, the first substrate further comprises a plurality of pixel electrodes, a pixel electrode is corresponding to a pixel area, and the pixel electrode has the substantially same voltage potential as an electric field being applied;
a second substrate disposed opposite to the first substrate; and
a liquid crystal layer disposed between the first substrate and the second substrate, and the liquid crystal layer including a plurality of liquid crystal molecules,
wherein the liquid crystal molecules in the pixel area corresponding to the datum line have a first tilt direction and a second tilt direction, and the first tilt direction and the second tilt direction are different.

2. The display apparatus of claim 1, wherein the range of the curvature radius is further between 2000 mm and 7500 mm.

3. The display apparatus of claim 1, wherein the included angle of the datum line and the first side is further between 85 degrees and 95 degrees.

4. The display apparatus of claim 1, wherein the included angle of the first tilt direction and the second tilt direction is between 170 degrees and 190 degrees.

5. The display apparatus of claim 1, wherein the liquid crystal molecules in the pixel area corresponding to the datum line further comprise a third tilt direction and a fourth tilt direction, and the first tilt direction, the second tilt direction, the third tilt direction and the fourth tilt direction are different.

6. The display apparatus of claim 1, wherein the included angle of the first tilt direction and the second tilt direction, the included angle of the first tilt direction and the third tilt direction, and the included angle of the second tilt direction and the fourth tilt direction are between 80 degrees and 100 degrees, respectively.

7. The display apparatus of claim 1, wherein the pixel area is divided into 8 sub-pixel areas.

8. The display apparatus of claim 1 further comprising:
a polarizing element disposed on one side of the first substrate away from the second substrate, wherein the included angle of absorption axis of polarizing element and the first tilt direction is between 35 degrees and 55 degrees.

9. The display apparatus of claim 1 further comprising:
a data line disposed corresponding to one of the pixel electrodes, wherein the included angle of the data line and the datum line is between 170 degrees and 190 degrees on the projection orientation of the first substrate.

10. The display apparatus of claim 9 further comprising:
a light shield area disposed on the second substrate, wherein the light shield area and the data line are overlaid on the projection orientation of the first substrate, and the included angle of the light shield area and the datum line is between 170 degrees and 190 degrees.

11. The display apparatus of claim 1, wherein the pixel electrode comprises an electrode pattern, and the electrode pattern comprises a first trunk electrode, a second trunk electrode and a plurality of first branch electrodes, the included angle of the first trunk electrode and the second trunk electrode is between 80 degrees and 100 degrees, the included angle of the first trunk electrode and the datum line is between 170 degrees and 190 degrees, and the included angle of the first trunk electrode or the second trunk electrode and the first branch electrode is between 35 degrees and 55 degrees.

12. The display apparatus of claim 11, wherein the included angle of the first trunk electrode and the second trunk electrode is further between 85 degrees and 95 degrees, the included angle of the first trunk electrode and the datum line is further between 175 degrees and 185 degrees, and the included angle of the first trunk electrode or the second trunk electrode and the first branch electrode is further between 40 degrees and 50 degrees.
